(19) United States
(12) Patent Application Publication
(10) Pub. No.: US 2004/0005915 A1
(43) Pub. Date: Jan. 8, 2004

(54) Image transmission

(76) Inventor: Andrew Arthur Hunter, Bristol (GB)

Correspondence Address: LOWE HAUPTMAN GILMAN & BERNER LLP, Suite 300, 1700 Diagonal Road, Alexandria, VA, 22314, US

(21) Appl. No.: 10/440,398

(22) Filed: May 19, 2003

(30) Foreign Application Priority Data
May 17, 2002 (GB) 0211250.6

(51) Int. Cl. H04B 1/38; H04M 1/00

(52) U.S. Cl. 455/575.1; 455/552.1; 455/550.1

(57) ABSTRACT

An image is automatically transferred between a camera and a communications device over a wireless link in response to an indication of contact being established over a wireless data network between the communication device and at least one predetermined destination resource or type of destination resource. The image is transferred from the communication device on to the data network through a data network interface.

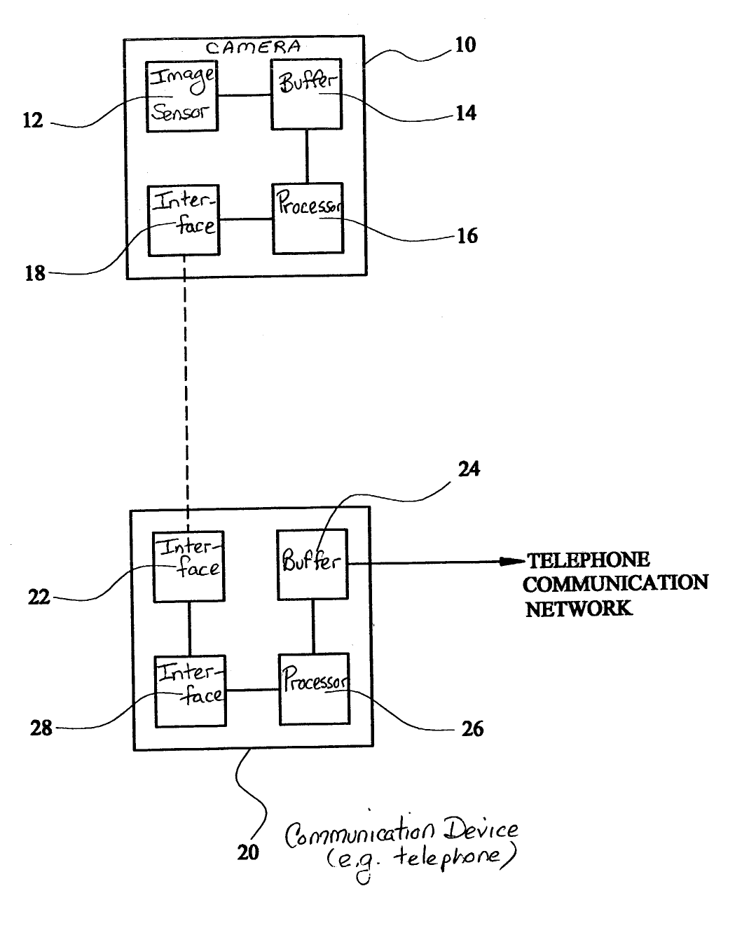

### FIELD OF THE INVENTION

This invention relates to transmission of image data.

### BACKGROUND TO THE INVENTION

Image capture devices, such as digital still or video cameras, are well known. In the light of recent technological advances, it is now possible to make such devices very small, small enough in fact to be embedded or disposed in, or otherwise mounted in or on, wearable devices such as eyeglasses, name badges, headgear, etc. and, for some time, service personnel, such as firemen and soldiers, have deployed such ‘wearable’ cameras during the performance of certain duties. In general, the purpose of such small, wearable cameras is to enable them to be carried (or worn) for a large part of every day, as opposed to being carried occasionally. They may also be arranged to be extremely convenient to use, either operating autonomously or by very simple user actions or interactions, or by voice commands, gestures, etc. Further, mobile telephone networks are evolving so as to be able to transmit data at sufficient rates and resolution to support video or still image data, if required.

Thus, it is known to provide a mobile telephone or similar device which can transmit image data captured by an image capture device across a telephone network to one or more desired recipients. In general, the image capture device is adapted to be embedded in a mobile telephone, or plugged into a communication port provided on the mobile phone in order to facilitate the transmission of image data from the camera to the mobile telephone for transmission and, in fact, mobile telephones with embedded cameras have been used to demonstrate the capabilities of the next generation of telephone infrastructure. However, such cameras add to the cost and size of the telephones and, because the telephones themselves are not truly wearable, they spend much of the time in the pocket, briefcase or handbag of a user.

U.S. Pat. No. 5,806,005 describes a portable image transfer system including a digital still camera which captures images in digital form and stores the images in a camera memory, a cellular telephone transmitter, and a central processing unit (CPU). The CPU controls the camera memory to cause it to output data representing an image and the CPU controls the cellular telephone transmitter to cause a cellular telephone to transmit the data received from the camera memory. A receiving station is coupled to the cellular telephone transmitter by a cellular network to receive image data and store the images. In order to enable the transmission of images captured by the camera across the cellular telephone network, it is necessary to establish a data link between the camera memory and the cellular telephone. This is established via the CPU and facilitated by a series of user and CPU commands.

Some existing digital cameras can be made to interoperate with telephones, but they require conscious interaction by the user, firstly to aim the camera and capture images and secondly to establish a data connection with a mobile telephone. It will be appreciated that this level of conscious interaction during a telephone call (when the user's attention should be primarily directed to the telephone conversation itself) is inappropriate.

Thus, in the case of all known systems, it is required to provide a physical wired data link between a camera and a mobile telephone in order to facilitate the transmission of image data captured by the camera across the mobile telephone network, or for the user to physically interact in some specific way with the mobile telephone and/or the camera in order to establish a communication link between them, which is inconvenient, especially if the user is actually conducting a telephone conversation with another party using the mobile telephone at the time that the communication link is required to be used. Further, unless the user has remembered to perform the specific action to establish the communication link before commencing the telephone call, the call may be temporarily disrupted while the user establishes the required communication link prior to the transmission of image data across the telephone network.

Mobile telephones are known with embedded cameras, but these do not facilitate convenient sending of images from an independently functioning and physically separate camera such as a wearable camera. Bespoke systems are also known, for example as disclosed in Japanese Patent Application Publication number 2002-187492 (Denso Corp) or DE-A-4238275 (Manowski), that combine a camera and mobile radio or telephone, but such systems do not facilitate convenient connection for image communication from an independent camera.

Some independent cameras can be connected to mobile phones directly or via a portable computer such as a laptop. For example these have been used by journalists for sending images from digital cameras back to publishers' offices. It is usually necessary to connect the camera and the phone by a wire link. Specific interaction with the camera or the phone is required to establish the connection or initiate image transfer.

Image transmission is only necessary or appropriate for a subset of telephone calls. For example, it may be appropriate to send images to a website when a phone accesses a particular data service or it may be appropriate to send images during a call to or from a video phone. For this reason a permanent connection to the phone is not appropriate. When making a call to a video phone it would be possible to anticipate a need to transmit images and to configure the connection in advance but it would be better to have the connection established without manual preparation. In other cases, such as receiving a call from a video phone, it may be necessary to connect the camera and initiate image transmission after the call has been answered, for example by sending display commands as in Japanese Patent Application Publication number 2002-044285 (Seiko Instruments Inc). It is not easy to maintain a voice conversation while interacting with a phone and or a camera to initiate image transfer, for example by attaching a detachable camera as described in EP-A 09751342 or by configuring a Bluetooth link between a phone and a camera.

### SUMMARY OF THE INVENTION

In accordance with a first aspect of the invention, there is provided a system for image capture and communication, comprising: a camera with an image memory and a first wireless communication interface; a communication device with a second wireless communication interface and a data network interface; and a user interface for creating a trigger event, wherein on creation of a trigger event, images from the image memory are transmitted over a wireless link established between the wireless communication interfaces and transmitted to a data network through the data network interface.

In accordance with a second aspect of the invention, there is provided a communication device programmed for onward communication of received images, the communication device comprising: a wireless communication interface for wireless communication with a camera; a data network interface for connection to a data network; and a processor programmed to recognise a trigger event, and on recognition of a trigger event to establish communication of images received over a wireless link to the camera through the wireless communication interface to the data network through the data network interface.

In accordance with a third aspect of the invention, there is provided a camera programmed for onward communication of received images, the camera comprising: image capture apparatus comprising an image sensor and an image memory; a wireless communication interface; and a processor programmed to recognise a trigger event, and on recognition of a trigger event to communicate one or more images from the image memory to a communication device through the wireless communication interface over a wireless link for onward transmission from the communication device.

In accordance with a fourth aspect of the invention, there is provided method of capturing and communicating images, comprising the steps of: programming a camera and a communications device to recognize a trigger event; one of the camera and the communications device recognising occurrence of the trigger event, and communicating with the other of the camera and the communications device by a wireless link therebetween; transferring images between the camera and the communications device over the wireless link; and transferring said images from the communications device on to a data network through a data network interface.

In accordance with a fifth aspect of the present invention, there is provided apparatus for transmitting image data captured by one or more image capture devices across a telephone network, comprising means for automatically establishing a wireless data link between said apparatus and said one or more image capture devices for transmitting image data captured by said one or more image capture devices to said apparatus, and/or automatically initiating data transmission therebetween, said data link being automatically established and/or said data transmission being automatically initiated in response to the performance of an operation in respect of said one or more image capture devices and/or said apparatus, said operation being unrelated to the establishment of said data link, or in response to some event related to said apparatus and said one or more image capture devices in relation to one another.

In accordance with a sixth aspect of the present invention, there is provided an image capture device comprising means for automatically establishing a wireless data link between said image capture device and apparatus for transmitting images captured by said image capture device across a telephone network for transmitting image data captured by said image capture device to said apparatus, and/or automatically initiating data transmission therebetween, said data link being automatically established and/or said data transmission being automatically initiated in response to the performance of an operation in respect of said image capture device or said apparatus, said operation being unrelated to the establishment of said data link, or in response to some event related to said apparatus and said image capture device in relation to one another.

The or each image capture device may be wearable by a user, for example, by being incorporated into a pair of eyeglasses, some form of headgear, or by being provided with a clip or other fastening means to enable it to be clipped or otherwise fastened about the user's person. However, the camera need not be wearable or portable. For example, it may be advantageous to provide cameras in public places (i.e. environmental cameras) to which a mobile telephone within a field of view of the camera can automatically establish a data link or initiate data transmission, thereby achieving video telephone calls without the complexity of cameras embedded in such telephones and with a better viewpoint. Thus, a data link can be established for transmission of image data from an image capture device to a mobile telephone or the like for transmission of the image data across a telephone network if desired, without having to move the image capture device itself, i.e. it can remain in place about the user's person.

The data link may be established, or data transmission may be initiated, automatically by the performance of some unrelated operation in respect of the mobile telephone or other communication apparatus, for example, switching it on, making a telephone call, making a telephone call to one or more predetermined numbers, searching the ‘phone book’ stored in the apparatus, receiving or answering a telephone call, etc. Alternatively, however, the data link may be established simply because the image capture device and the mobile telephone are within a predetermined distance of each other, irrespective of whether the telephone is being used or is even switched on to make or receive telephone calls.

The data link may immediately give rise to data transmission, or may enable transmission to take place automatically on occurrence of some future action, e.g. the camera autonomously capturing a picture, or a user issuing a voice command to the camera.

The establishment of a data link between the camera and a mobile telephone provides a number of potential advantages, for example:

1. It allows images from the camera to be viewed on the screen of the phone (perhaps specifically when the phone is not being used for some other purpose, e.g. triggered by the action of ending a call). In other words, the camera may be a very small wearable camera with no viewfinder or way of reviewing photographs, such that in one exemplary embodiment of the invention, when the phone is not being used to make calls, etc. it can be used as the viewfinder or as a way of reviewing captured images.

2. The purpose of the data link may be to establish a user interface with the camera via the phone, and in one exemplary embodiment of the invention, it may even be possible to use the telephone keypad to send commands to the camera.

3. The screen of the phone could also be used to allow one or more photos to be viewed and selected prior to transmission across the telephone network.

4. Alternatively, establishment of a link may simply enable data communication between the phone and the camera e.g. to exchange status information such as frame sizes and frame rates or data transfer rates

5. Establishment of the link or some other action to initiate data transmission may cause the camera configuration to change, e.g. may switch it on or change from low to high power operation or from low to high resolution mode, etc.

In any event, once a data link has been established, the image capture device may be arranged to periodically transmit a frame of image data to the mobile telephone to be transmitted, stored or discarded, according to whether or not the mobile telephone user actually wishes to transmit image data at that time. In a preferred embodiment, the mobile telephone may comprise a selection switch which, when actuated, causes image data to be selectively stored or transmitted across the telephone network. Thus, if the selection switch is not actuated, no image data is stored or transmitted, and image data (if any) sent from the image capture device to the mobile telephone is discarded. Alternatively or additionally, there may be a means to activate storage or transmission of images to a mobile telephone as a result of an operation of the camera, such as a touch or voice command.

The data link, once established may comprise a one-way data link from said image capture device to said mobile telephone or similar apparatus. In this case, when the event or circumstance occurs which causes the above-mentioned wireless data link to be established, the mobile telephone may transmit an initial signal, in response to receipt of which the image capture device may send an acknowledgement signal, after which process, a one-way data link is established from the image capture device to the mobile telephone across which the image capture device periodically transmits captured image data for transmission (or not) across the telephone network by the mobile telephone. In another embodiment, the image capture device (or the mobile telephone) may be arranged to transmit a relatively weak, short range enquiry signal periodically until it is acknowledged by the mobile telephone (or image capture device), thereby indicating that the two units are within a predetermined distance of each other and causing a data link to be established.

Of course, the data link may be two-way, in the sense that once it has been established it may be able to support communication by the mobile telephone to the image capture device as well as transmission of image data from the image capture device to the mobile telephone. In this case, for example, the mobile telephone may be arranged to transmit a trigger signal to the image capture device causing it to capture an image and transmit the corresponding image data to the mobile telephone for transmission thereof across the telephone network, if desired.

The data link may be supported by any suitable communication protocol, including short range radio waves or infra-red communication, for example. Images may be transmitted across the telephone network using progressive data transmission (i.e. so that detail can be sent progressively) with the result that such transmission can be terminated when sufficient detail has been sent.

In general, the present invention is intended to provide means for establishing a wireless data link between the image capture device and the mobile telephone, irrespective of whether communication actually takes place between them, without the need for specific user interaction with either unit.

It will be appreciated that the data link or data transmission established or initiated by the present invention may also be terminated as a result of an unrelated action or operation.

It is known for mobile telephones to support data instead of or as well as voice calls, in which case the present invention can be taken to relate also to the establishment of a data link or the initiation of data transmission as a result of use of a telephone to access a data service, e.g. an internet page such as a photo website or a photo printing service.

### BRIEF DESCRIPTION OF THE DRAWINGS

An embodiment of the present invention will now be described by way of example only and with reference to the accompanying drawing, in which:

The sole FIGURE is a schematic block diagram of apparatus according to an exemplary embodiment of the present invention.

### DETAILED DESCRIPTION OF THE INVENTION

Referring to The sole FIGURE of the drawings, apparatus according to an exemplary embodiment of the present invention, comprises a wearable camera 10, preferably head-mountable (embedded in or mounted on headgear, eyeglasses, etc.) comprising an image sensor 12, an image buffer 14 for storing image data representing one or more frames of captured image data, a processor 16 and a wireless communication interface 18. It will be appreciated that wearable cameras generally can operate without much conscious effort by their users. Further, they are not generally hidden in a user's pocket or handbag, but are worn so as to be ready for use as and when required. They can be head-mounted so that they track the approximate gaze of the wearer, and enable the user to capture images of scenes generally within their field of view without having to actually aim the camera in a separate operation. As such, it will be appreciated that they are particularly well suited for use during a telephone conversation.

The apparatus also comprises a communication device 20 comprising a second wireless communication interface 22, an image storage buffer 24 for storing image data received from the camera 10, a processor 26 and a primary wireless communications interface 28 providing a connection to a data network. For the preferred embodiment discussed here, communication device 20 is a mobile telephone and the data network is a cellular telephony network (of any type). However, the data network could also include other forms of data network, such as a conventional PSTN for wired telephony.

In use, when the mobile telephone is switched on, it may transmit a signal for receipt and acknowledgement by the camera 10 to establish a data link between the two units. Alternatively, the camera 10 may periodically transmit a signal which is received and acknowledged by the mobile telephone 20 to establish a data link between the two units when it is switched on and/or comes within a predetermined distance of the camera 10. Devices may have user-selected configurations such that proximity only serves to establish a link between appropriately configured devices, e.g. devices having the same owner. The data link may however only be established when a user-selected trigger event (such as receipt or initiation of a call with a particular number at the mobile telephone 20) occurs.

Essentially any wireless communication system appropriate for short range communication can be used for the wireless communication between the mobile telephone 20 and the camera 10. A particularly appropriate solution would be short range radio communication using the Bluetooth communication protocol (found at www.bluetooth.com), although, for example, systems involving infra-red could also be employed.

After the data link is established, the camera 10 can transmit (via the wireless communication link 16), in response to a trigger event, video or still image data representative of images stored in or being captured thereby, either continuously or periodically, for receipt by the mobile telephone. As described in further detail below, the trigger event can, for example, comprise receipt or initiation of a call by the mobile telephone 20. In the case where a camera has a microphone and/or can play back recorded audio data, such audio data may also be transmitted to the mobile telephone. This will typically be the case where a user wishes to send video to another user as a part of a telephone conversation—the user can preconfigure the mobile telephone to establish audio and video contact with particular users. In this case video may also be received at the mobile telephone 20 in addition to audio.

The camera 10, if a wearable camera, may also be associated with a display (such as an eyeglass display) in which case video may be sent back to the camera 10 also. The wireless link may be pre-existing, or may be set up only on the initiation of the call. The video transmission may be modified at the mobile telephone 20—for example, by eliminating a proportion of the frames to ensure that frames sent are sent with high quality of service, using approaches used in conference calling technologies.

Alternatively, the mobile telephone 20 may include means (not shown) for transmitting a trigger signal to the camera 10 to cause it to capture one or more images and transmit the respective image data via the data link to the mobile telephone 20—the trigger signal could alternatively be to collect all the images currently stored in the camera 10. The trigger signal would be sent to the camera when a user-selected or user-defined trigger event occurs, such as receipt or initiation by the mobile telephone 20 of a call from a particular number or address.

The telephone 20 is operable to recognize trigger events relating to establishment of contact over the data network between the communication device and at least one predetermined destination resource or type of destination resource. For example, the trigger event can be initiation or receipt of a voice or data call with a predetermined network resource such as a server providing a web service or digital storage facilities, or another mobile telephone, or any other suitable resource available on the network. The telephone 20 is configured to store details, for example network addresses, of network resources sufficient to enable the telephone to recognize when voice or data calls are made to or received from a particular resource, or from a particular type of resource, and to enable selection of a resource as a predetermined resource by a user. Recognition by the telephone that a trigger event has occurred is sufficient to initiate a transmission to send the images concerned across the telephone communication network.

The mobile telephone 20 may include user actuatable transmission means (not shown) which causes the image frame(s) already received or to be received by the mobile telephone 20 to be transmitted across the telephone communication network in response to a trigger event. The telephone 20 may display image frames on a display of the telephone 20 to facilitate user selection of frames for transmission across the network. In the event that the transmission means has not been actuated by the user, image data (if any) received by the mobile phone 20 is discarded and/or the camera is instructed by the telephone to cease its transmission.

The embodiments described above facilitate automatic establishment of image transmission between a phone and an independent camera as a result of an unrelated action such as making, ending or receiving an appropriate call, thus taking advantage of the hands-free operation of the camera without taking the user's attention away from the normal process of making or answering a call or holding a telephone conversation.

In the foregoing specification, the invention has been described with reference to specific exemplary embodiments thereof. It will, however, be apparent to a person skilled in the art that various modifications and changes may be made thereto without departing from the broader scope of the invention as set forth in the appended claims. Accordingly, the specification and drawings are to be regarded in an illustrative, rather than a restrictive, sense. It will be understood, for example, that the terms “camera” and “telephone” also refer to devices including camera and telephone behaviours respectively, for example, personal digital assistants (PDA's) having telephone capabilities.

1. A communication device for onward communication of received images, the communication device comprising: a wireless communication interface for wireless communication with a camera; a data network interface for connection to a wireless data network; and a processor for establishing communication of images received over a wireless link with the camera through the wireless communication interface to the data network through the data network interface in response to an indication of contact being established over the data network between the communication device and at least one predetermined destination resource or type of destination resource.

2. A communication device as claimed in claim 1, wherein the or each type of destination resource comprises at least one of a web service, a video communication device, an image display device and a digital data storage resource, the data network interface being arranged to couple signals with at least one of the web service, the video communication device, the image play device and the digital data storage resource.

3. A communication device as claimed in claim 1, wherein the destination resource includes a predetermined network address.

4. A communication device as claimed in claim 1, wherein the data network interface is arranged to receive data from the data network by the communication device as transmitted over the wireless link to the camera.

5. A communication device as claimed in claim 1, wherein the wireless interface is arranged to be responsive to a signal of a short range radio link.

6. A communication device as claimed in claim 1, wherein the wireless interface is arranged to establish the link automatically in response to the indication of the contact being established.

7. A communication device as claimed in claim 1, wherein the wireless interface is arranged to establish the link in response to indications of the camera and the communication device being in operation and within operation range of the wireless link.

8. A communication device as claimed in claim 1, wherein the processor is arranged to selectively configure the device in response to user activity so as to recognize the indication of the contact having been established in respect to said destination resources or types of destination resource selected by the user.

9. A system for image capture and communication, comprising: a camera including an image memory and a first wireless communication interface; and a communication device including a second wireless communication interface and a data network interface; the camera and communication device being arranged for causing images from the image memory (a) to be transmitted over a wireless link between the wireless communication interfaces and (b) to a wireless data network through the data network interface in response to an indication of contact being established over the data network between the communication device and at least one predetermined destination resource or type of destination resource adapted to be coupled to the data network.

10. A system as claimed in claim 9, wherein the or each type of destination resource comprises at least one of a web service, a video communications device and a digital data storage resource.

11. A system as claimed in claim 9, wherein the destination resource includes a predetermined network address.

12. A system as claimed in claim 11, wherein the camera is arranged to transmit a stream of images to the predetermined network address, the communication device being arranged to edit said stream of images before transmission to the predetermined network address.

13. A system as claimed in claim 9, wherein the communication device is arranged to transmit data received from the data network over the wireless link to the camera.

14. A system as claimed in claim 9, wherein the camera is a wearable camera.

15. A system as claimed in claim 9, wherein the communication device is arranged for establishing the wireless link automatically in response to the indication of the contact being established.

16. A method of capturing and communicating an image comprising the steps of: automatically transferring an image between a camera and a communications device over a wireless link in response to an indication of contact being established over a wireless data network between the communication device and at least one predetermined destination resource or type of destination resource; and transferring said image from the communication device on to the data network through a data network interface.

17. A method as claimed in claim 16, wherein the or each type of destination resource comprises at least one of a web service, a video communication device and a digital data storage resource.

18. A method as claimed in claim 16, wherein the destination resource includes a predetermined network address.

19. A method as claimed in claim 18, wherein a stream of images is transmitted from the camera to the predetermined network address.

20. A method as claimed in claim 16, further comprising the step of the communication device transmitting data received from the data network over the wireless link to the camera.

21. Apparatus for transmitting image data captured by one or more image capture devices across a wireless data network, comprising means for (a) automatically establishing a wireless data link between said apparatus and said one or more image capture devices for transmitting image data captured by said one or more image capture devices to said apparatus, and (b) automatically initiating data transmission therebetween, said means being arranged for automatically initiating transmission of the data transmission in response to an indication of contact being established over the data network between the communication device and at least one predetermined destination resource or type of destination resource.

22. Apparatus as claimed in claim 21, wherein the or each type of destination resource comprises at least one of a web service, a video communication device, an image display device and a digital data storage resource, the data network interface being arranged to couple signals with at least one of the web service, the video communication device, the image play device and the digital data storage resource.

23. Apparatus as claimed in claim 21, wherein the or each image capture device comprises a wearable camera.

24. Apparatus as claimed in claim 21, wherein said data link is arranged to be automatically established in response to said apparatus being switched on.

25. Apparatus as claimed in claim 21, wherein said apparatus is a mobile telephone and said data link is arranged to be automatically established in response to a user making or receiving a telephone call thereon.

26. Apparatus as claimed in claim 21, wherein said apparatus comprises a mobile telephone and said means is arranged for automatically establishing said data link in response to at least one of a user dialing a predetermined telephone number and the telephone receiving a call from a predetermined number.

27. Apparatus as claimed in claim 21, wherein said apparatus includes a mobile telephone and said means is arranged for automatically establishing a data link in response to one or more predetermined operations in respect thereof.

28. Apparatus as claimed in claim 21, wherein said means is arranged so that in response to being established, a user must perform another operation to transmit image data across said telephone network.

29. Apparatus as claimed in claim 21, wherein said means is arranged so that in response to said data link having been established, said one or more image capture devices are arranged to be transmitted as a continuous stream or periodic frames of captured image data to said apparatus, said apparatus comprising means for determining whether or not said image data are to be transmitted across said telephone network and for respectively transmitting or discarding said image data accordingly.

30. Apparatus as claimed in claim 21, wherein said apparatus is arranged to transmit a trigger signal to said one or more image capture devices, in response to receipt of which said one or more image capture devices are arranged to capture an image and transmit the corresponding image data to said apparatus or to transmit an already-captured image.
